(19) United States
(12) Patent Application Publication
(10) Pub. No.: US 2009/0206755 A1
(43) Pub. Date: Aug. 20, 2009

(54) LAMP TUBE STRUCTURE WITH REFLECTIVE SURFACE

(76) Inventors: HONG-BING TSAI, Hsinchu (TW); RUEY-SHI TSAI, Hsinchu (TW)

Correspondence Address: LEONG C LEI, PMB # 1008, 1867 YGNACIO VALLEY ROAD, WALNUT CREEK, CA, 94598, US

(21) Appl. No.: 12/030,885

(22) Filed: Feb. 14, 2008

(51) Int. Cl. H01J 17/16; H05B 7/06

(52) U.S. Cl. 313/635; 264/453

(57) ABSTRACT

Disclosed is a lamp tube structure with reflective surface. In this invention, the lamp tube structure with reflective surface can be achieved by forming a reflective layer on the inner surface or outer surface through coating, plating, chemical vapor deposition, sputtering, evaporation deposition or pasting. The lamp tube structure with reflective surface can also be achieved by the assembling the parts with reflective surface in combination with the transparent lamp tube or lamp tube parts, in this invention. The incorporation of the reflective surface lets the lamp light be utilized more effectively, and it is helpful to energy saving.

### BACKGROUND OF THE INVENTION

Lamp tubes such as fluorescent lamps are very common lighting devices. The radiation angle in radial direction of common lamp tubes is 360 degrees, namely, full angle. If a lamp tube stands vertically in a space of light requirement, a full angle of radiation lead to light the space effectively. However, if a lamp tube is mounted on the ceiling, a fraction of radiation toward the ceiling will be absorbed and will not provide lighting effectively. Some lamp devices of lamp tube use polished metal sheet (such as polished aluminum sheet) to make the lamp base with reflective surface, and the light radiated upward can be reflected downward to increase the lighting efficiency. The use of polished metal sheet does increase the lighting efficiency, but this also increases the cost of the lamp tube devices. If the reflective surface can be incorporated as the structure of lamp tube, there will be a chance to increase the lighting efficiency with lower cost.

### SUMMARY OF THE INVENTION

In this invention, a lamp tube structure with reflective surface is disclosed. The incorporation of the reflective surface lets the lamp light be utilized more effectively, and it is helpful to energy saving.

In order to save energy, the reflective surface should cover an enough area of the lamp tube. If the reflectivity of the reflective surface is close to 100%, and the circumferential angle covered by the reflective surface is 36 degrees (one tenth of the circumference of the lamp tube), the maximum intensity can be increased at a given direction is 10%. In some application area such as copy machine, scanner, liquid crystal display, etc., the light sources require directional radiation, and the required radiation angle of light sources may be only some degrees. The lamp tube structure of this invention can be used in such applications to increase the lighting efficiency and to provide convenience in some cases. Thus, the circumferential angle covered by the reflective surface of the lamp tube structure of this invention can be from 36 to 359 degrees, and is preferably from 90 to 358 degrees.

### BRIEF DESCRIPTION OF THE DRAWINGS

FIG. 1. Depiction of a well-known conventional lamp tube and its reflective cover

FIG. 2. Description of a stereo plot of lamp tube structure of the Examples

FIG. 3. Description of cross section structure of the lamp tube of the invention and the possible type of application

FIG. 4. Description of another type of application of the lamp tube structure of the invention

FIG. 5. Description of another type of application of the lamp tube structure of the invention

FIG. 6. Description of an outer insulating layer used in the lamp tube structure of the invention

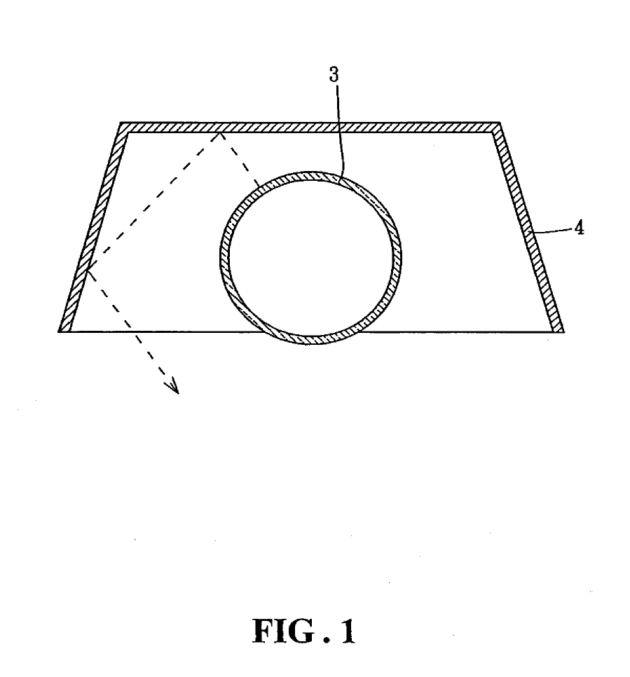

### DETAILED DESCRIPTION OF THE PREFERRED EMBODIMENT

The reflective surface for the lamp tube structure of this invention requires higher reflectance to increase the lighting efficiency, so does the material for forming the reflective surface. The reflective materials for reflective surface of the lamp tube structure of this invention can be aluminum (Al), silver (Ag), gold (Au), copper (Cu), zinc (Zn), nickel (Ni), palladium (Pd), platinum (Pt), alloy, mica, or other highly reflective materials.

The reflective surface of the lamp tube structure of this invention can be achieved by various techniques. The treatment of the existing lamp tube is an easy method. For example, the lamp tube can be coated with a reflective coating containing highly reflective particles such as silver powder, aluminum flake, nanometer sized silver particles, and a reflective layer is formed after drying. Also, the silver slurry that can form mirror surface is selectively coated on the lamp tube, and a reflective layer is formed after drying. Aluminum, nickel, or zinc can also be selectively plated onto the lamp tube to form the desired reflective surface. The area without reflective surface of the lamp tube is protected by a coating or photoresist, the lamp tube is placed in a deposition chamber, and the reflective layer is formed by chemical vapor deposition, sputtering, or evaporation deposition. Afterwards, the protecting layer is removed to form a lamp tube structure with reflective surface. A reflective film is cut to pieces with the desired shape and size, then, the piece is pasted on the lamp tube to form a lamp tube structure with reflective surface. Thus, the reflective layer can be formed on the existing lamp tube on the outer surface by coating, plating, chemical vapor deposition, sputtering, evaporation deposition or pasting to form a lamp tube structure with reflective surface.

In this invention, the lamp tube structure with reflective surface can be achieved by incorporation a reflective surface forming process during the manufacture of the lamp tube. The process compliant with the manufacture process of the lamp tube such as coating, plating, chemical vapor deposition, sputtering or evaporation deposition can be used as the reflective surface forming process. Thus, the lamp tube structure with reflective surface can be achieved by forming the reflective layer onto the inner or outer surface by coating, plating, chemical vapor deposition, sputtering or evaporation deposition during the manufacture of the lamp tube.

In this invention, the lamp tube structure with reflective surface can be achieved by the assembling of the reflective surface parts in combination with the transparent lamp tube or lamp tube parts. The metal sheet or foil with gloss surface can be used to make the reflective surface parts which can be fit or fastened on the existing lamp tube. Then the obtained reflective surface parts are assembled with the lamp tube to form the lamp tube structure with reflective surface.

In this invention, the lamp tube structure with reflective surface can be achieved by the assembling of the reflective surface parts in combination with the transparent lamp tube or lamp tube parts during the manufacture of the lamp tube. The airtight property is very important for the gas discharge lamps such as fluorescent lamps, and it is difficult to simply assemble the parts to obtain the desired airtight property. But the airtight property is not the major concern, or may be unnecessary, for the lamp tubes comprised of light emitting diodes (LED) or small incandescent lamps. Thus, the lamp tube without highly gastight requirement can be assembled by the reflective surface parts and the transparent lamp tube parts through mechanical methods such as mechanical joints, mortise and tenon joints, spring strips, or other suitable mechanical fittings to form the lamp tube structure with reflective surface. Transparent lamp tube parts can be produced by glass or transparent resins. Transparent lamp tube parts made from glass can be produced by casting. Transparent lamp tube parts made from transparent resins can be produced by suitable processing methods for the resins such as casting, injection molding, compression molding, extrusion, thermal forming, etc. The transparent resins can be unsaturated polyester resins, epoxy resins, CR-39 (an allyl carbonate resin), acrylics, polycarbonates, polystyrenes, cycloolefin copolymers, styrene-acrylonitrile copolymers, amorphous poly(ethylene terephthalate), polymethylpentenes, etc. The reflective surface parts can be produced from metal sheet, thin sheet or foil by suitable mechanical methods such as stamping, cutting, wire cutting, milling cutter, etc. The usable metal materials include aluminum, gold, zinc, nickel, alloy, etc. If necessary, the reflective surface parts can by polished after mechanical processing to form surface with high reflectance. Thus the reflective surface parts in and the transparent lamp tube parts can be produced separately, and then two kinds of parts are assembled to form the lamp tube structure with reflective surface.

Thus, disclosed is a lamp tube structure with reflective surface, and the incorporation of the reflective surface lets the lamp light be utilized more effectively, and it is helpful to energy saving. The lamp tube structure with reflective surface of this invention can be used in common lighting lamp tubes, and also in special light source applications such as copy machines, scanners, liquid crystal displays, etc.

### EXAMPLES

The examples which follow are illustrative of the present invention and are not intended to limit the scope, which is defined by the claims.

### Example 1

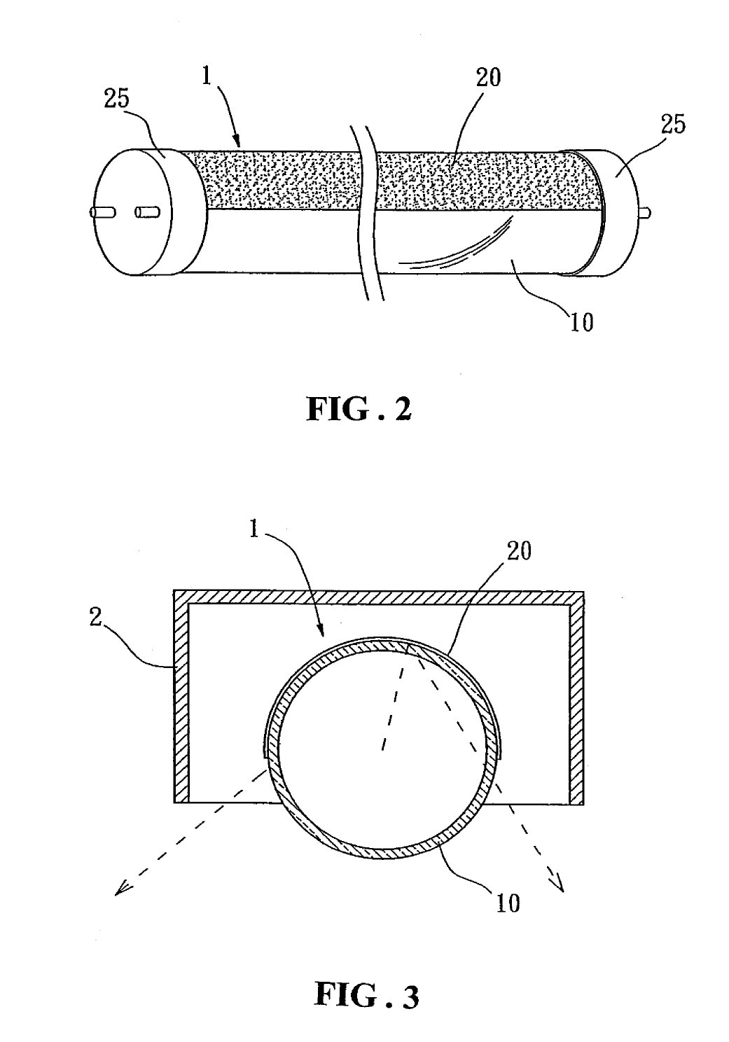

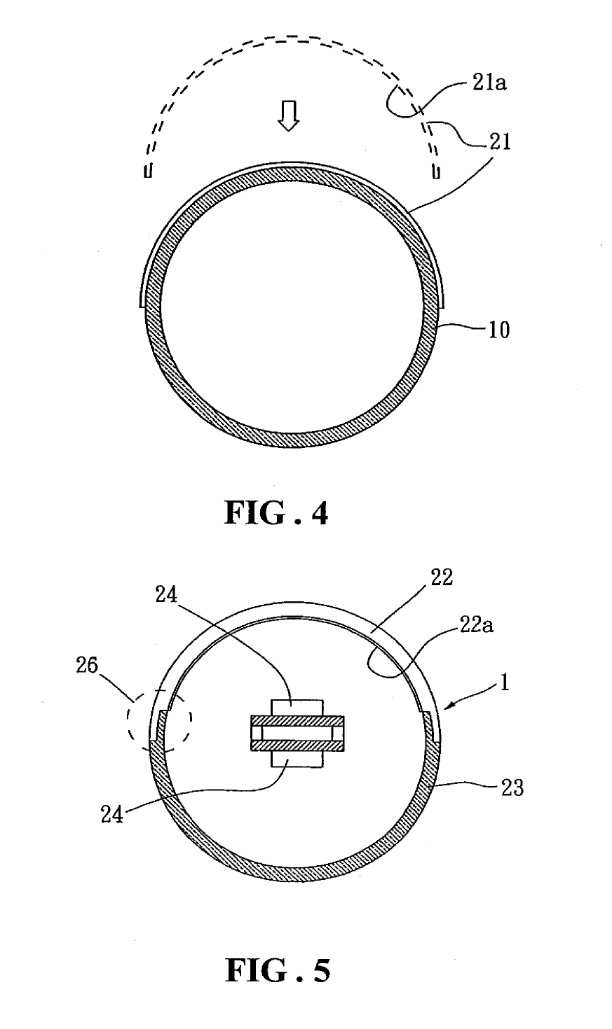

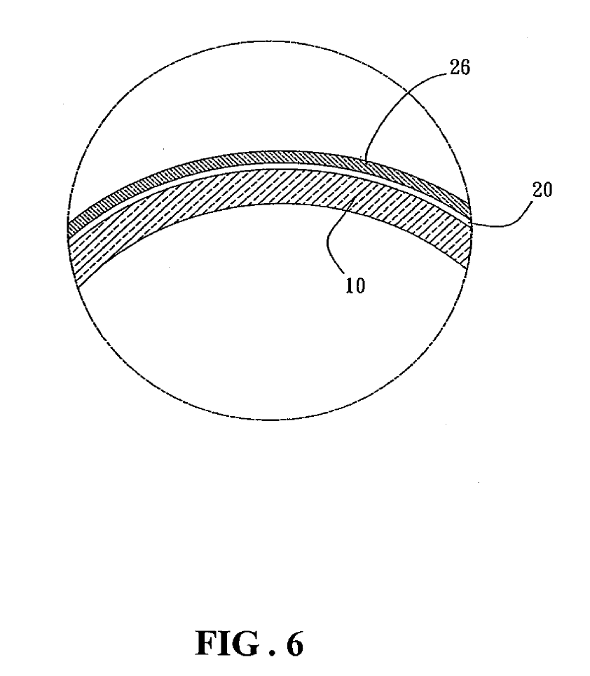

Please note FIG. 2, the smooth outer surface of a 20 W fluorescent lamp tube (1) was coated with a reflective paint to form a reflective layer (2). The coated area occupied the circumferential angle of 90, 135, 180, 220 and 270 degrees. After drying, the fluorescent lamp tube (1) was mounted on a simple lamp base (30). The power was turned on, and the radiation spectrum at a suitable distance from the lamp tube (1) was determined by a spectrophotometer. It could be seen obviously that the intensity of the lamp light increased as the area of reflective surface (or the coated circumferential angle) increased. In other words, under the conditions of non-360 degree (non-full direction) radiation, the incorporation of reflective surface will increase the efficiency of using the lamp light, and will be energy saving.

### Example 2

Please note FIG. 2, a 20 W fluorescent lamp tube (1) was covered and fit with a fitting part (101) with gloss surface inward. The occupied circumferential angle of reflective surface was 90, 180 and 270 degrees. Then, the fluorescent lamp tube (1) was mounted on a simple lamp base (3). The power was turned on, and the radiation spectrum at a suitable distance from the lamp tube (10) was determined by a spectrophotometer. The intensity of the lamp light increased as the circumferential angle covered by the reflective surface increased.

### Example 3

Please note FIG. 3 for this EXAMPLE. A half-tube part with joint ditch (101) was made by stamping the aluminum sheet. The inner surface of the part was polished to form reflective surface. A transparent half-tube part (102) was made by injection molding of an acrylic resin. The acrylic transparent half-tube part (102) was assembled onto the half-tube part with reflective surface to form the lamp tube (1) with reflective surface. A LED lamp string (103) was fit into the lamp tube (1), and the electric wires of the LED lamp string were connected to the two ends (104) of the lamp tube (1). Thus, the circumferential angle occupied by the reflective surface is 180 degrees. The power was turned on, and the radiation spectrum at a suitable distance from the lamp tube (1) was determined by a spectrophotometer. Under the conditions of non-360 degree (non-full direction) radiation, the incorporation of reflective surface increased light intensity.

What is claimed is:

1. A lamp tube structure with reflective surface wherein the circumferential angle covered by the reflective surface of the lamp tube is from 36 to 359 degrees, and is preferably from 90 to 358 degrees.

2. A lamp tube structure with reflective surface according to claim 1 wherein the reflective material for the reflective surface is aluminum (Al), silver (Ag), gold (Au), copper (Cu), zinc (Zn), nickel (Ni), palladium (Pd), platinum (Pt), alloy, mica, or other highly reflective materials.

3. A lamp tube structure with reflective surface according to claim 1 wherein the reflective layer for the reflective surface is formed on the existing lamp tube on the outer surface by coating, plating, chemical vapor deposition, sputtering, or evaporation deposition.

4. A lamp tube structure with reflective surface according to claim 1 wherein the reflective layer for the reflective surface is formed onto the inner or outer surface by coating, plating, chemical vapor deposition, sputtering or evaporation deposition during the manufacture of the lamp tube.

5. A lamp tube structure with reflective surface according to claim 1 wherein the structure is achieved by assembling of the reflective surface parts the transparent lamp tube or lamp tube parts.

6. A lamp tube structure with reflective surface according to claim 1 wherein the reflective surface parts which can be fit or fastened on the existing lamp tube are made from metal sheet or foil, and then assembled with the existing lamp tube to form the structure.

7. A lamp tube structure with reflective surface according to claim 1 wherein the structure is achieved by the assembling of the reflective surface parts with the transparent lamp tube or lamp tube parts during the manufacture of the lamp tube.

8. A lamp tube structure with reflective surface according to claim 1 wherein the structure is achieved by assembling the reflective surface parts and the transparent lamp tube parts through mechanical methods such as mechanical joints, mortise and tenon joints, spring strips, or other suitable mechanical fittings.

9. A method for assembling the lamp tube structure with reflective surface according to claim 8 wherein the transparent lamp tube parts are produced from glass by casting, or from transparent resins by casting, injection molding, compression molding, extrusion or thermal forming.

10. A method for assembling the lamp tube structure with reflective surface according to claim 9 wherein the transparent resin is unsaturated polyester resins, epoxy resins, CR-39(an allyl carbonate resin), acrylics, polycarbonates, polystyrenes, cycloolefin copolymers, styrene-acrylonitrile copolymers, amorphous poly(ethylene terephthalate) or polymethylpentenes.

11. A method for assembling the lamp tube structure with reflective surface according to claim 8 wherein the reflective surface part is produced from sheet, thin sheet or foil of aluminum, gold, zinc, nickel or alloy metal by suitable mechanical methods such as stamping, cutting, wire cutting or milling cutter.
